(19) United States
(12) Patent Application Publication
(10) Pub. No.: US 2005/0097717 A1
(43) Pub. Date: May 12, 2005

(54) Machining tool

(76) Inventor: Bret Rasmussen, Neenah, WI (US)

Correspondence Address: WILHELM LAW SERVICE, S.C., 100 W LAWRENCE ST, THIRD FLOOR, APPLETON, WI, 54911, US

(21) Appl. No.: 10/703,260

(22) Filed: Nov. 6, 2003

(51) Int. Cl. B23P 13/04

(52) U.S. Cl. 29/26 A; 409/236; 408/237; 29/558

(57) ABSTRACT

A machining tool comprises a support structure, and a standard extending therefrom. The standard comprises a tool holder adapted to removably receive a rotary tool. The tool holder employs a reciprocating mechanism to move such rotary tool nearer to, or further from a workpiece. Such rotary tool is removably connected to a chuck, the chuck being adapted to accommodate a bit of larger diameter than the rotary tool is adapted to receive. The machining tool having a mechanism adapted to control the speed of such rotary tool.

### BACKGROUND

In woodworking and other crafts, it is often necessary to cut intricate openings through a piece of wood or other material. Known processes for cutting such openings are time consuming and laborious. In a typical known process, an initial hole is first drilled through the workpiece. Then a scroll saw blade is threaded through the initial hole and mounted to the scroll saw. After the cut is made, the saw blade is removed from the machine and the workpiece opening, re-threaded through another pre-drilled initial hole, and remounted to the machine. The process is repeated for each opening required. The multiple set-up and take-down steps necessary for each opening result in substantial lost time.

Another method of cutting openings in a piece of material involved a conventional router in combination with a stand, such as is shown in U.S. Pat. No. 6,223,794. The stand holds the router over a table that supports the workpiece. The initial hole for the opening is drilled prior to using the router. Alternately, the initial hole is formed by manually tilting the router and bit at an angle to the workpiece and then manually plunging the bit into the material. That operation is dangerous, because a router bit is designed to cut on its sides, not at a point. The side cutting force on the bit can jerk the router in the user's hands. Moreover, it is difficult to control the size and location of the initial hole. Consequently, another tool, such as an electric drill with a twist drill bit, is usually used to form the initial hole. Another problem with the machine of the U.S. Pat. No. 6,223,794 was that the line of sight from the user to the bit was partially blocked by elements of the router.

U.S. Pat. No. 5,853,036 discloses a cutting apparatus for routing the ends of molding sections. The router bit is in view during operation. However, the longitudinal axis of the router bit is always oblique to the plane of the workpiece and oblique to the directions of movement of the router bit.

To the inventor's knowledge, no machine is available that has both a range of speeds sufficient to effectively utilize both the plunge drilling capabilities and the side cutting capabilities of a combination bit, and the bit-size accepting versatility to accept both a relatively smaller diameter combination bit and/or side cutting bit, and a relatively larger diameter bit, e.g. a conventional plunge drilling bit.

A further limitation regarding known combination bits is that known bits are not available in diameters smaller than about 0.25 inches. That size is too large to produce many intricate openings in artistic workpieces, such as craft items.

Conventional high speed rotary tools, those with operating speed of around 30,000 rpm and higher enable users to make a cut into a workpiece using the side cutting surface of a rotary tool bit. Conventional high speed rotary tools accept bits of a limited size variety, as compared to conventional relatively lower speed drills and drill presses. A conventional rotary tool uses a collet to secure a bit, thereby limiting the “usable bit size” to a size which corresponds to the collet; whereas a conventional drill uses an adjustable chuck, the adjustable chuck accommodating a wider variety of bit sizes than a rotary tool collet.

Typically, high speed rotary tools are manipulated with both hands of a user. The tool is advanced, or otherwise maneuvered relative to a workpiece; thus, the workpiece remains still and tool is moved to achieve the desired result.

Some conventional high speed rotary tools are multi-speed, or variable speed devices. The speed control mechanism is typically located on the rotary tool, itself. By locating the rotary tool speed control on the rotary tool, during use of a conventional rotary tool, the user utilizes only one of his or her hands to control the rotary tool, as the other hand adjusts the speed control, which can be dangerous.

### SUMMARY

A machining tool comprises a table, a standard, a tool holder to hold a high speed rotary tool, and a chuck. Some embodiments include an apparatus to control the speed of the high speed rotary device.

Machining tools of the present invention enable a user to perform both plunge drilling operations, and high speed rotational cutting operations without having to change bits, and without having to manually stabilize and/or manipulate the high speed rotary tool relative the workpiece. Accordingly machining tools of the invention enable a user to use both his or her hands to manipulate the workpiece while performing a machining operation on the workpiece. Alternatively, the user can adjust the speed of the rotary tool without having to simultaneously hold, support, and control the rotary tool, because support is provided by the machining tool.

In some embodiments, the speed control apparatus is located sufficiently far from the rotary tool to enable a user to adjust the speed without positioning his ro her appendages near the rotating mechanism of the rotary tool.

In a first family of embodiments, a machining tool has a support structure comprising a table, the table having at least one aperture formed therethrough; a tool holder support extending upwardly from the support structure; a tool holder mounted to the tool holder support, the tool holder comprising a slide which is reciprocable along a longitudinal axis of the tool holder, wherein the longitudinal axis is aligned with one of such at least one aperture formed through the table; an electric tool removably mounted to the tool holder slide, the electric tool having a rotatable output shaft; a chuck mounted on one of the electric tool and the tool holder, and connected for rotation to the rotatable output shaft; and electric speed control apparatus controlling the speed of rotation of the rotatable output shaft of the electric tool between a first relatively slower speed and a second relatively higher speed.

In some embodiments, the second speed is at least eight times faster than the first speed.

In some embodiments, the tool holder support extends upwardly from the table.

In some embodiments, the apparatus further comprises a bit gripped in the chuck, the bit having a distal end adapted for plunge drilling and a side cutting portion disposed away from the distal end, the electric speed control apparatus controlling the speed of the electric tool rotatable output shaft between a first relatively slower speed for a plunge-type drilling operation using the drill point of the bit and a second relatively higher speed for a side cutting operation using the side cutting portion of the bit.

In some embodiments, the bit has a diameter of approximately 0.06 inch.

In some embodiments, the longitudinal axis of the tool holder is substantially perpendicular to the table, and a view of the bit during the drilling and cutting operations is generally unobstructed to a person using the apparatus.

In some embodiments, the support structure has a bottom, the table having a top sufficiently above the bottom of the support structure that the machining tool can be placed on a first selected surface, with the table top providing a second surface, a space being disposed between the first and second surfaces and receiving the distal end of the bit below the table for accommodating side-cutting operations performed by a side portion of the bit displaced from the distal end of the drill bit.

In some embodiments, the first speed is about 1000 rpm to about 5000 rpm, and the second speed is about 10,000 rpm to about 35,000 rpm.

In some embodiments, the bit has an effective diameter substantially less than approximately 0.20 inch.

In some embodiments, the electric tool has a plug for connecting the electric tool to a power source, the control apparatus comprising a power regulator and an outlet, the outlet being adapted to receive such plug of the electric tool.

In some embodiments, the chuck has a chuck input shaft extending upwardly from the chuck, the chuck input shaft communicating with the rotatable output shaft of the electric tool.

In some embodiments, the rotatable output shaft of the electric tool has an axis of rotation, the chuck input shaft having an axis of rotation generally coaxial with such axis of rotation of the rotatable output shaft.

In some embodiments, the chuck input shaft has a diameter D1, and the rotatable output shaft of the electric tool has a diameter D2, the chuck being adapted to receive a bit with a diameter up to D3, the diameter D3 being greater than at least one of diameter D1 and diameter D2.

In a second family of embodiments, the invention comprehends a machining tool comprising support structure; a table mounted to the support structure; a tool holder support supported by the support structure and extending upwardly therefrom; a tool holder mounted to the tool holder support, the tool holder comprising a guide and a chuck, the tool holder guide accommodating movement of the tool holder toward and away from the table; rotating drive apparatus for rotating the chuck, the rotating drive apparatus superposing the chuck, whereby the drive apparatus is adapted to communicate with a rotary tool removably mounted to the tool holder.

In some embodiments, the machining tool further comprises an aperture in the table, in alignment with an axis of rotation of the chuck; and a space between a bottom of the support structure and a top of the table, the space receiving a distal end of the bit below the table, thereby to facilitate side-cutting operations performed by portions of the bit which are displaced from the distal end of the bit.

In some embodiments, the rotating drive apparatus comprises an electric tool removably mounted in the tool holder guide and having a drive shaft drivably connected to the chuck; the electric tool having a rotatable output shaft, and electric speed control apparatus controlling speed of the electric tool rotatable output shaft for varying speed of rotation of the electric tool rotatable output shaft.

In some embodiments, the electric speed control apparatus comprises a speed control which controls the electric tool rotatable output shaft to rotate at speeds from a relatively slower speed of about 1000 rpm to about 5000 rpm, to a relatively higher speed of about 10,000 rpm to about 35,000 rpm.

In some embodiments, the electric speed control apparatus controls the electric tool rotatable output shaft to rotate with speed variability of at least about eight to one.

In some embodiments, the tool holder guide reciprocates along an axis which is substantially perpendicular to the table, and wherein a line of sight between a person using the apparatus and the bit in contact with a workpiece is generally unobstructed.

In a third family of embodiments, the invention comprehends a method of cutting a workpiece, comprising gripping a bit in a chuck driven by an electric rotary tool having a rotatable output shaft; rotating the rotatable output shaft of the electric rotary tool and correspondingly rotating the bit at a first speed; while rotating the rotary electric tool at the first speed, advancing the bit a first distance longitudinally along an axis of rotation of the bit, and thereby drilling a through hole in the workpiece, as a plunge-drilling action, and advancing the bit beyond the first distance to a stop locus; rotating the bit at a second speed substantially greater than the first speed; while rotating the bit at the second speed, advancing the workpiece along a selected path while contacting a side portion of the bit and thereby making an elongate linear cut in the workpiece.

In some embodiments, the rotating of the bit at the first relatively slower speed comprises rotating the bit at a speed of about 1000 rpm to about 5000 rpm, and the rotating of the bit at the second relatively greater speed comprises rotating the bit at a speed of about 10,000 rpm to about 35,000 rpm.

In some embodiments, the bit at the second relatively greater speed rotates the bit at a speed which is at least about eight times faster than the first speed.

In some embodiments, the advancing of the bit comprises advancing the bit in a direction substantially perpendicular to a surface of the workpiece, and the advancing of the workpiece is accompanied by a relatively unobstructed view of the bit where the bit is in cutting contact with the workpiece.

It is an object of the invention to provide a machining tool for cutting, drilling, or otherwise machining a workpiece, which accommodates a wide variety of bit sizes, and is adapted for variable speed use; the variable speed range including a relatively high rotational speed, e.g. 30,000 rpm.

It is another object of the invention to provide a machining tool for cutting, drilling, or otherwise machining a workpiece, which enables a user to removably attach an electric tool to a chuck.

It is yet another object to provide a method of cutting a workpiece wherein a user rotates a tool at a first, relatively slower rotational speed so as to perform a plunge-drilling action into a workpiece; subsequently, while rotating the tool at a second, relatively higher rotational speed, the user advances the workpiece along a selected path.

### BRIEF DESCRIPTION OF THE DRAWINGS

FIG. 1 shows a first perspective view of a first embodiment of machining tools of the invention.

FIG. 2 shows a second perspective view of the embodiment of FIG. 1.

FIG. 3 shows a third perspective view of the embodiment of FIG. 1, making a plunge-cut hole.

FIG. 4 shows a fourth perspective view of the embodiment of FIG. 1, making a side cut.

FIG. 5 shows a top view of a typical workpiece worked on by machine tools of the invention.

FIG. 6 shows a side elevation view of a portion of a bit useful in machining tools of the invention.

FIG. 7 shows an exploded perspective view of a portion of the machining tool of FIG. 1.

FIG. 8 shows a perspective view of a portion of the machining tool of FIG. 1.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

Although the disclosure hereof is detailed and exact to enable those skilled in the art to practice the invention, the physical embodiments herein disclosed merely exemplify the invention, which may be embodied in other specific structure. The scope of the invention is defined by the claims appended hereto.

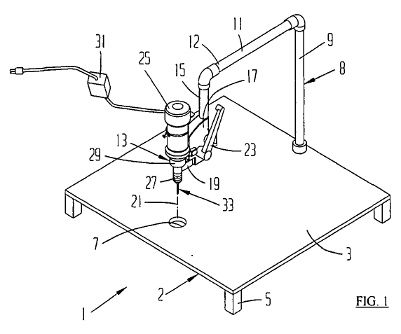

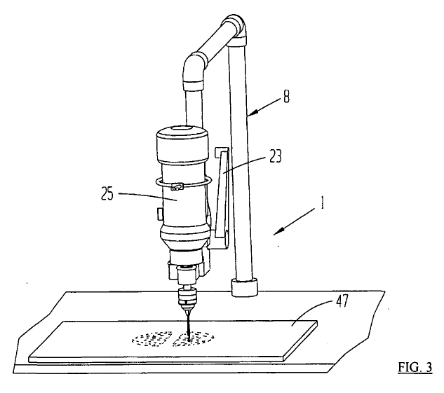

FIGS. 1-4 refer to embodiments of machining tools 1 of the invention, which are used for both plunge drilling of, and high speed spiral cutting of a workpiece. Generally, the embodiment of FIGS. 1-4 is a machining tool 1. The machining tool comprises a table 3, which supports a workpiece 47, standard 9, which supports, orients, and mounts tool holder 13 in relation to table 3. Tool holder 13 is adapted to receive electric rotary tool 25.

The combination of table 3, standard 9, and tool holder 13, enables the user to perform drilling and cutting operations to workpiece 47 with electric rotary tool 25 while minimizing the utilization of the user's human motor function resources, e.g. hand manipulation, needed to support, control, manipulate and orient electric rotary tool 25. Thus, machining tool 1 enables a user to allocate the user's manual dexterity towards workpiece 47, enabling the user to intricately control manipulation of workpiece 47 relative to electric rotary tool 25.

Referring specifically, now, to the drawings, FIG. 1 illustrates a first embodiment of machining tool 1. Machining tool 1 has support structure 2, which includes table 3. Table 3 is supported by a plurality of legs 5. In some embodiments, table 3 comprises a metallic material. Metal table 3 is advantageous because of the strength/rigidity of the metallic material, and relatively heavy weight of the metallic material which contributes to overall stability of machining tool 1.

Preferred metallic materials of table 3 are materials, which resist corrosion. In some embodiments, table 3 is made of stainless steel, which resists corrosion, and which provide strength/rigidity to support structure 2. In other embodiments, table 3 is made of aluminum, which resists corrosion, and provides strength/rigidity to support structure 2. Aluminum is relatively light as compared to steel, so aluminum table 3 contributes to the portability of machining tool 1, enabling a user to more easily move machining tool 1.

In some embodiments, table 3 is made of other metallic materials, e.g. steel. Non-stainless steel alloys are relatively less resistant to corrosion, but are also less costly. Thus, a user of machining tool 1 maintains a corrosion free surface of table by painting or lightly oiling the surface of table 3, when resistance to corrosion is desired, or by maintaining a low moisture environment about machining tool 1. In some embodiments, table 3 is painted, alternatively powder coated prior to retail sale of machining tool 1. In other embodiments, table 3 is galvanized, or otherwise zinc-plated to resist corrosion.

In some embodiments, table 3 comprises a wood-based material. Some embodiments include a solid wood table 3. Solid wood table 3 is preferably a hard wood, such as oak, for the relative strength and durability the hard wood provides to support structure 2. Preferred embodiments include a wood table 3 comprising an engineered wood product, which offers dimensional stability, e.g. resists expanding, contracting, warping/cupping, as compared to natural wood table 3 under conditions of varying ambient temperature and/or varying humidity.

Table 3 has at least one, alternatively a plurality of apertures 7 formed therethrough. At least one of the apertures 7 is positioned below electric tool 25, in axial alignment with bit 33 which is driven by electric tool 25. Aperture 7 defines an opening sufficiently large, that bit 33 can penetrate the aperture 7. When the bit is performing a side cutting operation after penetrating aperture 7, the end 37 of bit 33 is generally below the surface of table 3, exposing side cutting edges 43 of bit 33 to workpiece 47.

Extending downwardly from table 3 are legs 5. In some embodiments, legs 5 are relatively short, e.g. 2-6 inches. The bottom of each of legs 5 is in supportive communication with an underlying support structure commonly found in a workshop, such as a table/workbench. Legs 5 elevate table 3 a sufficient distance above the top of the supporting structure to enable a user of machining tool 1 to descend the end 37 of bit 33 into and through aperture 7, without the end 37 of bit 33 penetrating an underlying surface of the support structure e.g. a workbench.

In some embodiments, legs 5 are relatively long, e.g. 36-42 inches, alternatively longer/shorter. The bottom of each of legs 5 is in supportive communication with a ground surface, e.g. the floor of a shop. Where machining tool 1 is supported from a ground-lever surface, the lengths of legs 5 support the working elements of the machining tool 1 at a height whereby the user can comfortably control the machining tool 1 while the machining tool 1 is being used for its intended purpose.

In some embodiments, legs 5 are adjustable to enable the user to sequentially position machining tool 1 on support surfaces having different heights. A user adjusts legs 5 to a relatively longer length to accommodate being placed on a relatively short work bench, and adjusts legs 5 to a relatively shorter length to accommodate being placed on a relatively taller work bench. In some embodiments, adjustable legs 5 comprise telescoping leg sections, which use detents or friction mechanisms, e.g. “stop bolts” to retain the telescoping sections at the desired positions.

Extending upwardly from support structure 2, specifically from table 3, is standard 8. Standard 8 comprises upwardly oriented post 9, horizontally oriented arm 11 and downwardly oriented arm 15. Attached to the portion of arm 15, which is most remote from arm 11, is tool holder 13.

In some embodiments, post 9 extends upwardly from the surface of table 3. Post 9 is connected to table 3 near, alternatively adjacent to, the back edge of table 3, distal from aperture 7. The position of post 9, relative to the upper surface area of table 3 enables a user of machining tool 1 to utilize substantially the entire surface area of the table as a working surface. Thus, a user can manipulate work piece 47 across and upon the entire upper surface of table 3.

In some embodiments (not shown), post 9 extends upwardly from support structure 2, but not through table 3. Rather, post 9 is attached to, and extends upwardly from the outermost surface of one of legs 5, alternatively from a bracket connecting at least 2 of legs 5, leaving the entire upper surface of table 3 unobstructed.

In some embodiments, post 9 is pivotally attached to support structure 2. Pivotally attached post 9 enables a user of machining tool 1 to pivot standard 8, and thus electric tool 25, laterally away from table 3 when vertical clearance above table 3 is desirable, e.g. as a user initially positions a large workpiece 47 upon table 3. In preferred embodiments, the pivotal attachment of post 9 includes a detent to “snap lock” post 9 into the position in which bit 33 superposes aperture 7; thus providing an audible, or visible, or touch-detectable feedback, indicating to the user that bit 33 has bee accurately oriented over aperture 7, preferably after workpiece 47 has been positioned upon table 3 with the workpiece visually covering aperture 7.

In preferred embodiments, arm 11 extends from, and is perpendicular to post 9. The length of arm 11 corresponds to the distance between post 9 and aperture 7, so as to orient bit 33 above aperture 7. Arm 11 has enough strength/rigidity to provide effective load bearing support to holder 13 and electric tool 25. Arm 11 transfers forces applied to holder 13 and electric tool 25 into support structure 2 via post 9. Such forces include gravitational forces, torsional forces created by the rotating mechanisms of electric tool 25, and forces transferred from a user through workpiece 47 while advancing workpiece 47 relative to bit 33 during cutting operation.

In some embodiments, standard 8 includes downwardly-dependent arm 15, extending downwardly from generally longitudinal arm 11. The length of arm 15 generally corresponds to the length of post 9. In some embodiments, post 9 is relatively long and arm 15 is correspondingly relatively long. In other embodiments, post 9 is relatively short and arm 15 is correspondingly relatively short. The distance between table 3 and the intersection of post 9 and arm 11, in combination with the downward displacement of arm 15 from the intersection of arm 15 and arm 11, positions holder 13, electric tool 25, and bit 33 at an appropriate height above table 3.

In some embodiments, standard 8 is of one piece construction with post 9, arm 11, and arm 15 being integral with post 9. Standard 8 is made of e.g. round tubular steel bent at approximately 90 degree at two loci to accommodate suspending electric tool 25, and thus bit 33, above table 3.

In some embodiments, standard 8 is an assembly comprised of post 9, arm 11, and arm 15 in combination with suitable connections and/or connectors. Post 9 is then attached to arm 11, and arm 11 is attached to arm 15 by e.g. welding, riveting, bolting, screwing, or by other conventional affixation means.

In some embodiments, tool holder 13 is attached to arm 15. Tool holder 13 has a base 17 which is fixedly mounted to arm 15. Slide 19 is reciprocably mounted to base 17. Accordingly, slide 19 reciprocates relative to the tool holder base 17 along a longitudinal axis 21 that is perpendicular to table 3.

Referring now to FIGS. 1, 2, and 3, reciprocation of slide 19 along base 17 is achieved by pivoting/rotating handle 23, e.g. by a conventional rack and pinion system to convert rotating motion into linear motion. Rotating handle 23 correspondingly rotates a gear within base 17. The rotating gear in base 17 engages a rack affixed to slide 19, forcing the rack and thus slide 19, to either climb upwardly away from table 3, or downwardly toward table 3, depending on the direction of rotation of the rotating gear in base 17.

In some embodiments, electric rotary tool 25 is removably attached to tool holder slide 19. Electric rotary tool 25 is e.g. clamped to holder slide 19 to align the rotary tool 25 with aperture 7. In preferred embodiments, electric rotary tool 25 has a rotating output shaft 26 capable of high speed rotation e.g. 35,000 rpm, alternatively greater than 35,000.

Known high speed rotary tools are adapted to accept bits into the rotating mechanism, at the distal end of the rotating output shaft 26, by means of a compression fit using a sleeve structure, e.g. a collet. A bit is inserted into the collet, which is accepted into the rotating mechanism. The collet nut is tightened which corresponding compresses the collet, the compressed collet grippingly securing the bit within the rotating mechanism.

Known high speed rotary tools utilize bits with a side cutting surface, such as sharpened flutes. The conventional side cutting bit is rotated at high speeds e.g. 30,000-35,000 which enables a user to move the bit through work material using the side cutting elements of a conventional high speed rotary tool bit e.g. an Advantage High-Speed Rotary Saw™ bit, or a Spiral Saw” Zip® bit. A preferred rotary tool 25 is produced by the Roto Zip Tool Corporation, under the trademark Roto Zip®.

Such high speed rotary tool can only receive a bit with a shank diameter corresponding to the size of the collet. However, conventional collets are of limited sizes which correspond to the size of the rotating apparatus, e.g. rotating output shaft 26. Conventional collects used in high speed rotary tools are 1/4 inch or ⅛, some collets being smaller. Accordingly, conventional high speed rotary tools typically do not accommodate bits having shank diameters greater than 1/4 inch, as limited by the diameter of the rotating mechanism, e.g. output shaft diameter D1. The user of a conventional high speed rotary tool is correspondingly limited to performing functions, which can be performed using a bit of up to 1/4 inch diameter.

Referring again to FIG. 1, in some embodiments, tool holder 13 has guide 29 formed therein. Guide 29 has an annular opening formed therethrough, which accommodates a bearing, alternatively a set of bearings to be installed. The bearings in guide 29 are adapted to have a rotatable shaft inserted therethrough.

In some embodiments, chuck 27 is rotatably attached to tool holder 13 at guide 29. Chuck 27 has a tool facing end and a bit facing end. Fixedly attached to the tool facing end of chuck 27 is a rotatable input shaft 28. Rotation of the rotatable chuck input shaft 28 correspondingly rotatably drives chuck 27. Rotatable chuck input shaft 28 extends from chuck 27, through the bearings in guide 29, and terminates above the top of guide 29, leaving a portion of chuck input shaft 28 exposed above guide 29.

In preferred embodiments, chuck input shaft 28 has a diameter D2 of no greater than 1/4 inch. When attaching rotary tool 25 to holder slide 19, the user inserts chuck input shaft 28 into the collet of rotary tool 25, and subsequently tightens the collet nut, thereby removably attaching the rotating mechanism of rotary tool 25 to chuck 27. Once rotary tool 25 and chuck 27 are coupled, rotating mechanism of rotary tool 25 correspondingly rotates chuck 27.

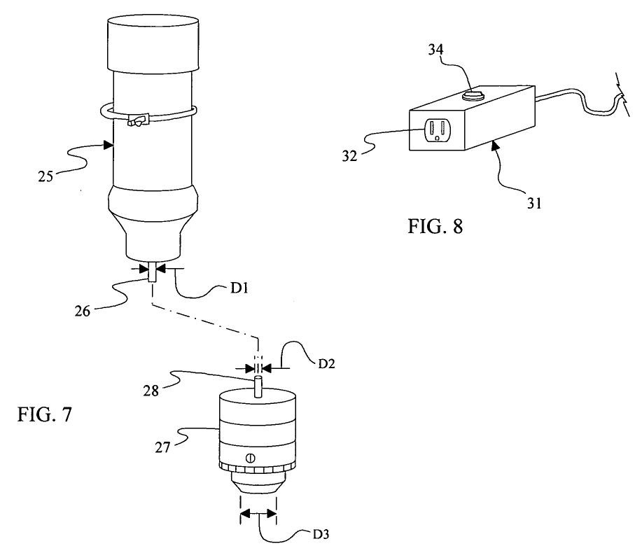

Referring specifically to FIG. 7, In some embodiments, chuck 27 is a conventional chuck as used in portable drills and drill press machines. Chuck 27 has a variable diameter opening to accommodate individual bits having different shank diameters. In some embodiments, chuck 27 has a maximum opening diameter D3 of 3/8 inch, which enables a user of machining tool 1 to insert individual bits, each having a shank diameter up to 3/8 inch, into chuck 27. In other embodiments, chuck 27 has a maximum opening diameter D3 of 1/2 inch, which enables a user of machining tool 1 to insert individual bits, each having a shank diameter up to 1/2 inch, into chuck 27.

Chuck 27 enables a user of machining tool 1 to utilize bits having diameters up to 3/8 inch, alternatively bits having diameters up to 1/2 inch for drilling and cutting operations, thus increasing the versatility of a conventional high speed rotary tool 25. Machining tool 1 enables a user to have both the high speed capabilities of a conventional high speed rotary tool 25, in combination with the bit size accommodation versatility of chuck 27.

As show in FIG. 1, some embodiments of machining tools 1 include a an electronic control apparatus, which can be a power regulator e.g. speed control 31.

In preferred embodiments, speed control 31 has a power cord and a plug which connects speed control 31 to an alternating current source, at an outlet 32. The power cord of rotary tool 25 is plugged into the outlet on speed control 31. A user of machining tool 1 uses speed control 31 to vary the motor rotational speed of rotary tool 25.

Alternating current motor speed controllers are widely available. In some embodiments, speed controller 31 employs a variable resister, e.g. a potentiometer, alternatively a rheostat which varies the resistance and correspondingly varies the voltage in the circuit, and thus varies the speed of rotation of rotary tool 25 at output shaft 26.

In some embodiments, the user rotates a dial 34, alternatively manipulates a slide, on speed controller 31 to correspondingly control the rotational speed created by rotary tool 25. In other embodiments, the user pivots a foot pedal to regulate speed controller 31, which correspondingly controls the rotational speed created by rotary tool 25. Suitable foot pedals, e.g. foot switches are presently available from Conntrol International, Inc., headquartered in Putnam, Conn.

Speed controller 31 also enables a user to vary the speed of rotary tool 25, thus the user can perform consecutive, different functions using machining tool 1. For example, an initial relatively low speed plunge drill step penetrates workpiece 47, followed by raising rotational speed of bit 33, and performing a high speed cutting operation using the side cutting elements of the bit.

Bits which combine both drilling and cutting features and are of relatively small diameter, e.g. 1/8 inch or smaller, are preferred for performing a combination function, the combination function consisting of an initial plunge drilling action followed by a rotational side cutting action. Performing such operations with such small bits enable the user to fabricate more intricate designs than when a larger bit must be used. Having the bit held laterally stationary enables the user to manipulate the workpiece with both hands, on a stationary surface, whereby precision of the cuts being made is enhanced. Where a small diameter bit is used, e.g. about 0.06 inch to about 0.20 inch, the small bit size further contributes to the intricate detain which can be embodied in the finished product.

Speed controller 31 also enables the user of machining tool 1 to perform conventional drilling procedures/operations. Accordingly, machining tool 1 enables a user to perform more operations upon a workpiece than can be performed by a conventional rotary tool. As one example, the user operates machining tool 1 to perform a plunge drilling operation. The user inserts a conventional twist drill bit into chuck 27, and adjusts speed controller 31 to a relatively lower rotational speed adapted to produce desired drilling results for the specific size of bit being used, when considering the material composition of workpiece 47.

As a further example, machining tool 1 enables the user to rotate a plunge drilling bit at a relatively lower speed to bore holes into/through a metallic workpiece, preferably using cutting oil, or other liquid lubricant/penetrant to lubricate and reduce temperature of the workpiece.

As another example, machining tool 1 enables a user to bore holes into/through a wood workpiece. To bore a hole into/through a wood workpiece, the user rotates a plunge drilling bit at a relatively higher speed than the rotational speed required to bore a hole into/through a metallic workpiece.

Machining tool 1 enables a user to perform side cutting operations in addition to plunge drilling operations. To perform a side cutting operation, a user rotates a side cutting bit or combination bit at a relatively higher speed than the speed required to perform a hole plunge drilling operation upon a workpiece.

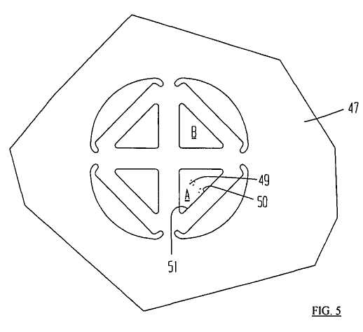

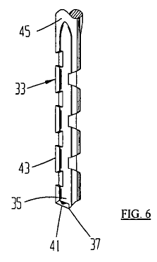

Referring specifically to the process of cutting out the pattern in workpiece 47, as illustrated in FIG. 5, the machining tool 1 is placed on the top surface of a conventional work bench. The short height of the legs 5, as illustrated in FIG. 1, locates the table 3 so as to be approximately as convenient to the operator as the work bench top surface itself. Further, the heavy weight of the frame 2 maintains the machine in place on the work bench without moving from its desired location. A workpiece 47 is placed on the machine table 3. An area A that is to be cut out of workpiece 47 is placed in alignment with the tool holder axis 21.

A desired combination drill and cutting bit 33 is mounted in chuck 27. The speed controller 31 is adjusted to energize the electric tool 25 at a relatively slow speed, such as approximately 3,000 rpm. The actual speed is dependent on the material of the workpiece 47 and also on the diameter of the bit 33. The operator holds the workpiece with one hand and pivots the tool holder lever 23 with the other hand.

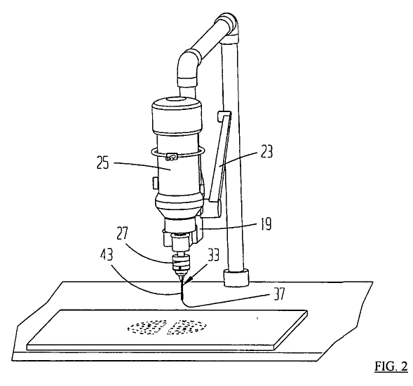

Referring now to FIG. 2, as the user pivots the tool holder lever 23tool slide 19 advances toward the workpiece in the manner of a conventional drill press. Upon contact of the bit end 37 with the workpiece, with the bit rotating, the operator exerts sufficient force on the tool holder handle to cause the distal end of bit 33 to penetrate through the workpiece and enter the table hole 7. That action causes an initial hole, such as initial hole 49 in FIG. 5, to be drilled through the workpiece. The tool holder lever is further pivoted to position the side cutting edges 43 of the bit in the initial hole 49. The operator then locks the tool holder slide 19 to the base 17.

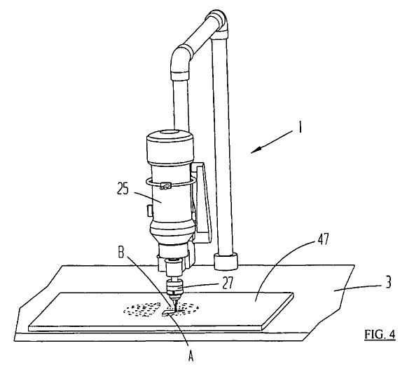

The operator then adjusts the speed controller 31 to energize the electric tool to a very high speed of perhaps approximately 30,000 rpm. Using two hands, the operator slides the workpiece 47 on the table 3 along a desired path to cut the perimeter 51 of an opening, such as the opening A of FIGS. 4 and 5. At all times, the combination drilling and cutting bit 33, as well as the perimeter 51 of the workpiece opening A, are in full view of the operator. The small diameter of the bit enables small radius curves, namely almost sharp corners, to be cut in the opening.

As soon as the opening A has been full cut out, the tool holder slide 19 is unlocked. The handle 23 is reverse pivoted to withdraw the combination drill and cutting bit 33 from, and to a position above the opening, so as to enable moving the workpiece fully about table 3 without the bit doing any cutting of the workpiece. Such withdrawal of the bit comprehends vertical movement. The workpiece 47 is slid on the frame table 3 until a desired next opening B is under the bit. The speed controller 31 is adjusted to lower the electric tool speed to that suitable for plunge drilling the next initial hole for the opening B, and the process is repeated. In that manner, multiple openings are cut in the workpiece without removing either the bit 33 from the chuck 27 or the electric tool 25 from the tool holder 13.

In summary, the advantages of conventional electric tools 25, such as a Roto Zip electrical tool, can now be more fully realized and supplemented. The machining tool 1 of the invention provides both rapid cutting of intricate openings in a workpiece 47 as well as convenience to an operator. This desirable result comes from using the combined functions of the machine frame 2 and the electric control 31. The heavy frame enables the workpiece to be slid laterally on the table at a convenient location but without the table moving relative an underlying work bench. The electric control adjusts the speed of the electric tool for two distinctly different cutting operations: a relatively slow speed for plunge drilling operations, and a much higher speed for side cutting operations. The combination drill and cutting bit 33 both makes an initial hole in the workpiece, and cuts along a desired path 51 to cut the complete opening. The small diameter of the bit enables small radius corners, namely almost sharp corners, to be produced in the openings.

It will also be recognized that in addition to the superior performance of the machining tool 1, construction of a tool of the invention is such as to be of modest cost in comparison to the benefits provided by the tool. In fact, the machining tool quickly pays for itself because of increased productivity.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A machining tool adapted to perform drilling and cutting operations on a workpiece, said machining tool comprising:
(a) a support structure comprising a table, said table having at least one aperture formed therethrough;
(b) a tool holder support extending upwardly from said support structure;
(c) a tool holder mounted to said tool holder support, said tool holder comprising a slide which is reciprocable along a longitudinal axis of said tool holder, wherein the longitudinal axis is aligned with one of such at least one aperture formed through said table;
(d) an electric tool removably mounted to said tool holder slide, said electric tool having a rotatable output shaft;
(e) a chuck mounted on one of said electric tool and said tool holder, and connected for rotation to said rotatable output shaft; and
(f) electric speed control apparatus controlling the speed of rotation of the rotatable output shaft of said electric tool between a first relatively slower speed and a second relatively higher speed.

2. Machining tool as in claim 1 wherein the second speed is at least eight times faster than the first speed.

3. Machining tool as in claim 1 wherein said tool holder support extends upwardly from said table.

4. Machining tool as in claim 1, said machining tool further comprising a bit gripped in said chuck, said bit having a distal end adapted for plunge drilling and a side cutting portion disposed away from the distal end, said electric speed control apparatus controlling the speed of the electric tool rotatable output shaft between a first relatively slower speed for plunge-type drilling using the drill point of the bit and a second relatively higher speed for side cutting using the side cutting portion of said bit.

5. Machining tool as in claim 4 wherein said bit has a diameter of approximately 0.06 inch.

6. Machining tool as in claim 4 wherein the longitudinal axis of said tool holder is substantially perpendicular to said table, and a view of said bit during the drilling and cutting operations is generally unobstructed to a person using the machining tool.

7. Machining tool as in claim 4 wherein said support structure has a bottom, said table having a top sufficiently above the bottom of said support structure that said machining tool can be placed on a first selected surface, with said table top providing a second surface, a space being disposed between the first and second surfaces and receiving the distal end of said drill bit below said table for accommodating side-cutting operations performed by a side portion of said bit displaced from said distal end of said drill bit.

8. Machining tool as in claim 4 wherein the first speed is about 1000 rpm to about 5000 rpm, and wherein the second speed is about 10,000 rpm to about 35,000 rpm.

9. Machining tool as in claim 4 wherein the second speed is at least eight times faster that the first speed.

10. Machining tool as in claim 4 wherein said bit has an effective diameter substantially less than approximately 0.20 inch.

11. Machining tool as in claim 1, said electric tool having a plug for connecting said electric tool to a power source, said control apparatus comprising a power regulator and an outlet, said outlet being adapted to receive a such plug of said electric tool.

12. Machining tool as in claim 1, said chuck having a chuck input shaft extending upwardly from said chuck, said chuck input shaft communicating with said rotatable output shaft of said electric tool.

13. Machining tool as in claim 12 wherein said rotatable output shaft of said electric tool has an axis of rotation, said chuck input shaft having an axis of rotation generally coaxial with such axis of rotation of said rotatable output shaft.

14. Machining tool as in claim 12 wherein said chuck input shaft has a diameter D1, and said rotatable output shaft of said electric tool has a diameter D2, said chuck being adapted to receive a bit having a diameter up to D3, said diameter D3 being greater than at least one of diameter D1 and diameter D2.

15. Machining tool for performing drilling and cutting operations on a workpiece, said machining tool comprising:
(a) support structure;
(b) a table mounted to said support structure;
(c) a tool holder support supported by said support structure;
(d) a tool holder mounted to said tool holder support, said tool holder comprising a guide and a chuck, said tool holder guide accommodating movement of said tool holder toward and away from said table; and
(e) a chuck input shaft for rotating said chuck, said chuck input shaft superposing said chuck, whereby said chuck input shaft is adapted to communicate with an electric tool removably mounted to said tool holder.

16. Machining tool as in claim 15, further comprising an aperture in said table, in alignment with an axis of rotation of said chuck and a space between a bottom said support structure and a top of said table, said space receiving a distal end of a bit, held in said chuck, below said table for accommodating side-cutting operation performed by portions of said bit which are displaced from said distal end of said drill bit.

17. Machining tool as in claim 15 wherein said rotating drive apparatus comprises an electric tool removably mounted in said tool holder guide and having a drive shaft drivably connected to said chuck, said electric tool having a rotatable output shaft, and electric speed control apparatus controlling speed of the electric tool rotatable output shaft for varying speed of rotation of said electric tool rotatable output shaft.

18. Machining tool as in claim 17 wherein said electric speed control apparatus comprises a speed control which controls said electric tool rotatable output shaft to rotate at speeds from a relatively slower speed of about 1000 rpm to about 5000 rpm, to a relatively higher speed of about 10,000 rpm to about 35,000 rpm.

19. Machining tool as in claim 17 wherein said electric speed control apparatus comprises a speed control which controls said electric tool rotatable output shaft to rotate with speed variability of at least about eight to one.

20. Machining tool as in claim 16 wherein the tool holder guide reciprocates along an axis which is substantially perpendicular to said table, and wherein a line of sight between a person using said machining tool and said bit in contact with a workpiece is generally unobstructed.

21. Machining tool as in claim 17, said electric tool having a plug for connecting said electric tool to a power source, said control apparatus comprising a power regulator and an outlet, said outlet being adapted to receive a such plug of said electric tool.

22. Machining tool as in claim 17, said chuck having a chuck input shaft extending upwardly from said chuck, said chuck input shaft communicating with said rotatable output shaft of said electric tool.

23. Machining tool as in claim 22 wherein said rotatable output shaft of said electric tool has an axis of rotation, said chuck input shaft having an axis of rotation generally coaxial with such axis of rotation of said rotatable output shaft.

24. Machining tool as in claim 22 wherein said chuck input shaft has a diameter D1, and said rotatable output shaft of said electric tool has a diameter D2, said chuck being adapted to receive a bit having a diameter up to D3, said diameter D3 being greater than at least one of diameter D1 and diameter D2.

25. A method of cutting a workpiece, comprising:
(a) gripping a bit in a chuck driven by an electric tool, the electric tool having a rotatable output shaft;
(b) rotating said rotatable output shaft of said electric rotary tool and correspondingly driving the bit at a first speed;
(c) while rotating the rotatable output shaft of the electric tool at the first speed, and thereby driving the bit at the first speed, advancing the bit a first distance longitudinally along an axis of rotation of the bit, and thereby drilling a through hole in the workpiece, as a plunge-drilling action, and advancing the bit beyond the first distance to a stop locus;
(d) rotating the bit at a second speed substantially greater than the first speed; and
(e) while rotating the bit at the second speed, and while holding the bit at the stop locus, advancing the workpiece along a selected path while contacting the workpiece at a side portion of the bit and thereby making an elongate linear cut in the workpiece.

26. A method as in claim 25 wherein the rotating of the bit at the first relatively slower speed comprises rotating the bit at a speed of about 1000 rpm to about 5000 rpm, and wherein the rotating the bit at the second relatively greater speed comprises rotating the bit at a speed of about 10,000 rpm to about 35,000 rpm.

27. A method as in claim 25 wherein rotating the bit at the second relatively greater speed comprises rotating the bit at a second speed which is at least about eight times faster than the first speed.

28. A method as in claim 25 wherein the advancing of the bit comprises advancing the bit in a direction substantially perpendicular to a surface of the workpiece, and the advancing of the workpiece is accompanied by a relatively unobstructed view of the bit where the bit is in cutting contact with the workpiece.
